(19) United States
(12) Patent Application Publication
(10) Pub. No.: US 2001/0043007 A1
(43) Pub. Date: Nov. 22, 2001

(54) Breaker using pneumatic and hydraulic pressures

(75) Inventor: Sang-Kyu Jang, Jeollabuk-do (KR)

Correspondence Address: Richard S. Milner, Cooper & Dunham LLp, 1185 Avenue of the Americas, New York, NY, 10036, US

(73) Assignee: Dong Nam Heavy Industries Co., Ltd., Jeonju-shi (KR)

(21) Appl. No.: 09/850,309

(22) Filed: May 7, 2001

(30) Foreign Application Priority Data
May 9, 2000 (KR) 2000-24580

(51) Int. Cl. B25D 16/00

(52) U.S. Cl. 299/69; 299/100; 173/90; 173/200

(57) ABSTRACT

A breaker, used for breaking target hard objects, such as reinforced concrete structures, rocks or hard soil, using pneumatic and hydraulic pressure, is disclosed. In the breaker, the piston is multi-stepped to form first, second and third oil chambers between the piston and the cylinder. First, second, third and fourth oil paths are formed in the sidewall of the cylinder. The first oil path extends from the oil inlet port to the first chamber, thus feeding pressurized oil from an external oil source to the first chamber. A valve chamber is formed in the sidewall of the cylinder. The second oil path allows the valve chamber to selectively communicate with the second chamber. A directional control valve unit is installed within the valve chamber, and selectively returns the pressurized oil from the first chamber to the valve chamber prior to feeding the oil from the valve chamber to the second chamber through a plurality of oil ports and the second oil path. The third oil path selectively communicates with the valve chamber through the valve unit when the piston axially moves within the cylinder. The fourth oil path discharges the pressurized oil from the third chamber through an oil drain path, thus making the pressure of the third chamber become zero and initializing the pressure of the third chamber.

### BACKGROUND OF THE INVENTION

1. Field of the Invention

The present invention relates to a breaker, or an attachment removably attached to a heavy vehicle, such as a power shovel, and used for breaking target hard objects, such as reinforced concrete structures, rocks or hard soil, and, more particularly, to a breaker using pneumatic and hydraulic pressures, the breaker being operable by a reciprocating action of a piston within a cylinder created by both pneumatic pressure of nitrogen gas introduced into a gas chamber defined within the upper portion of the cylinder bore and hydraulic pressure of actuation oil, an orifice formed on an oil outlet port of the cylinder at a predetermined position and used for controlling both the oil flow and oil pressure during an operation of the breaker, thus allowing the breaker to perform a high speed hammering mode and a low speed hammering mode.

2. Description of the Prior Art

As well known to those skilled in the art, breakers are designed to intermittently apply pneumatic or hydraulic pressure to the top surface of a piston within a cylinder, thus reciprocating the piston within a predetermined range to allow the piston to periodically hammer the head of a chisel. The tip of the chisel, exposed outside of the cylinder, thus breaks target hard objects, such as reinforced concrete structures, rocks or hard soil.

In a conventional breaker, pressurized nitrogen gas is introduced into the gas chamber defined within the cylinder at a position above the piston, while the head of a chisel is coaxially set within the cylinder at a position under the piston such that the head of the chisel is intermittently hammered by the reciprocating piston. In an operation of the breaker, highly pressurized actuation oil flows into the oil chamber defined within the cylinder at a position under the piston, thus moving the piston within the cylinder upwardly while compressing the nitrogen gas within the gas chamber until the piston reaches the upper dead point. When the piston completely reaches the upper dead point, the highly pressurized actuation oil is exhausted from the cylinder through an oil outlet port formed at the middle portion of the cylinder. In such a case, the exhaust oil, flowing in the oil outlet port, controls the valve unit provided at the oil outlet port, thus making the gas chamber act as a high-pressure chamber.

That is, the oil chamber under the piston is evacuated of the highly pressurized actuation oil, while the nitrogen gas within the gas chamber is highly pressurized. In such a case, the highly pressurized nitrogen gas pushes the piston downward within the cylinder, thus making the piston coaxially hammer the head of the chisel. The tip of the chisel thus hammers and breaks a target hard object, such as a reinforced concrete structure or rock.

In the conventional breaker, the hammering force is created by the gas expansion force, which is formed by highly pressurized nitrogen gas within the gas chamber. Therefore, when it is desired to increase the hammering force of the conventional breaker, the size of the breaker must be enlarged. However, such a large-scaled breaker is undesirably required to be used with a large-scaled and large-capacity heavy vehicle.

In addition, it is necessary for the conventional breakers to have complex oil paths in order to form a desired high pressure within the gas chamber during an operation. Therefore, the conventional breakers undesirably have a complex construction.

In an effort to overcome the problems experienced in the conventional breakers, a variety of breakers, designed to increase the hammering force and control the valve unit using a simple oil path without changing the size, weight or shape of the conventional breakers, have been proposed.

For example, Korean Patent Publication No. 1990-32045 discloses “a hydraulic and pneumatic breaker”. In the above hydraulic and pneumatic breaker, highly pressurized oil is supplied to the first oil chamber defined in the cylinder at a position under the piston, thus compressing the gas contained in the gas chamber defined in the cylinder at a position above the piston. When the gas within the gas chamber is compressed to the maximum pressure, the highly pressurized oil is discharged from the first oil chamber to the second oil chamber provided in the cylinder at a position above the piston. The oil pressure within the second oil chamber cooperates with gas pressure in the gas chamber, thus increasing the hammering force of the piston acting on the head of the chisel.

Another example may be referred to Korean Patent Publication No. 1994-5811 disclosing “a breaking unit using both pneumatic pressure and hydraulic pressure”. In the above braking unit, the passage formed by both the second oil chamber of the cylinder and the oil port of the valve unit is directly opened or closed without using the highly pressurized oil port of the valve sleeve of the valve unit. Therefore, when the piston reaches the upper dead point within the cylinder while compressing the gas within the gas chamber, the oil is introduced into the valve control chamber defined between the valve sleeve and the valve spool, thus axially moving the valve spool within the valve sleeve to open the oil port of the valve unit. Therefore, the highly pressurized oil flows into the second oil chamber defined in the cylinder at a position above the piston, thus increasing the hammering force of the breaker. This breaker also improves the operational efficiency of the valve unit used for controlling the flow of highly pressurized oil.

However, the above-mentioned breakers are problematic in that excessive expansion force caused by hydraulic pressure acts on both the entire outer surface of the cylindrical valve spool of the valve unit and the entire inner surface of the valve sleeve, thus failing to accomplish a smooth movement of the valve spool relative to the valve sleeve. In such a case, scratches are undesirably formed on the entire outer surface of the valve spool, thus reducing the hammering energy of the piston. This also reduces the expected life span of the breaker.

In addition, the valve spool of the valve unit included in the breakers does not smoothly respond to the oil flow or oil pressure during an oil control process of the valve unit, and so the valve spool cannot smoothly move relative to the valve sleeve, thus resulting in a formation of scratches on both the outer surface of the valve spool and the inner surface of the valve sleeve. Such scratches limit the stroke of the valve spool within the valve sleeve, thus deteriorating the hammering function of the breaker.

### SUMMARY OF THE INVENTION

Accordingly, the present invention has been made keeping in mind the above problems occurring in the prior art, and an object of the present invention is to provide a breaker, which is operable using pneumatic and hydraulic pressures, and of which the passage formed by both a second chamber of the cylinder defined above the piston and an oil port of the valve sleeve is directly opened or closed, thus moving the valve spool within the valve sleeve without being disturbed by hydraulic pressure, and which has at least one self-pressure space within the stroke of the valve spool inside the valve sleeve and a plurality of depressions on the outer surface of a guide plug of the valve unit, thus creating an oil film effect between the valve sleeve and the valve spool and preventing a formation of undesired scratches on the inner surface of the valve sleeve or the outer surface of the valve spool.

In order to accomplish the above object, the present invention provides a breaker using pneumatic and hydraulic pressures, comprising a chisel, a chisel case receiving the chisel and guiding an axial movement of the chisel within a stroke, a cylinder assembled with the chisel case and coaxially receiving a piston used for hammering the chisel, and a gas chamber provided at an upper end of the cylinder and containing nitrogen gas and selectively compressing the nitrogen gas in response to an axial movement of the piston within the cylinder, further comprising: first and second stepped surfaces formed on the outer surface of the piston, thus changing the outer diameter of the piston and forming first and second chambers between the outer surface of the piston and the inner surface of the cylinder; a third chamber defined between the piston and the cylinder at a position between the first and second chambers; a first oil path formed in the sidewall of the cylinder and allowing an oil inlet port of the cylinder to communicate with the first chamber, thus feeding pressurized oil from an external oil source to the first chamber; a valve chamber formed in the sidewall of the cylinder while extending from the first oil path in a direction opposite to the first chamber; a second oil path formed in the sidewall of the cylinder so as to allow the valve chamber to selectively communicate with the second chamber; a directional control valve unit installed within the valve chamber and used for selectively returning the pressurized oil from the first chamber to the valve chamber prior to feeding the pressurized oil from the valve chamber to the second chamber through a plurality of oil ports thereof and the second oil path; a third oil path formed in the sidewall of the cylinder at a position between the first and second oil paths, and selectively communicating with the valve chamber through the valve unit in response to an axial movement of the piston within the cylinder; and a fourth oil path formed in the sidewall of the cylinder at a position around the third oil path, and used for discharging the pressurized oil from the third chamber through an oil drain path, thus making the pressure of the third chamber become zero and initializing the pressure of the third chamber.

In the preferred embodiment of the present invention, a plurality of stepped surfaces are formed on the outer surface of the piston axially received within the cylinder. Due to the stepped surfaces of the piston, a plurality of gaps are formed between the outer surface of the piston and the inner surface of the cylinder. That is, the first and second chambers are defined between the piston and the cylinder at the top and bottom of the stroke. During an operation of the breaker, highly pressurized oil is fed into the first chamber. On the other hand, highly pressurized oil or statically pressurized oil is selectively fed to the second chamber in response to an axial movement of the valve spool within the valve sleeve of the directional control valve unit operated in conjunction with an axial movement of the piston within the cylinder. A lower step is formed on the piston at a position around the first chamber, while an upper step is formed on the piston at a position around the second chamber, with a depression formed on the piston between the upper and lower steps. The multi-stepped outer surface of the piston and the multi-stepped inner surface of the cylinder define a plurality of desired oil chambers selectively communicating with a plurality of oil paths.

A plurality of annular grooves are formed at the junction of the piston and the cylinder at the top and bottom of the stroke, with a plurality of sealing members held in the annular grooves and used for preventing a leakage of oil and gas. The sealing members also effectively absorb operational vibration of the piston during an axial movement of the piston within the cylinder. In addition, a dust wiper seal is preferably set in the lower end of the cylinder so as to prevent external impurities from being introduced into the cylinder. A groove is formed on the inner surface of the cylinder at a position around the dust wiper seal. This groove discharges undesired remaining oil from the cylinder.

An oil accumulator is mounted on the sidewall of the cylinder, and communicates with the first chamber of the cylinder. This oil accumulator prevents an undesired variation of the actuation oil pressure within the cylinder during an operation of the breaker. The oil accumulator thus allows the breaker to perform a reliable operation while reducing operational vibration and being free from an undesired loosening of oil pipe couplings during an operation.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view of a breaker in accordance with the preferred embodiment of the present invention;

FIG. 2 is a sectional view of the breaker of this invention taken along the line A-A of FIG. 1;

FIG. 3 is a sectional view of the valve sleeve included in a valve unit of the breaker of this invention;

FIG. 4 is a sectional view of the valve spool included in the valve unit of this invention;

FIG. 5 is a sectional view of a guide plug included in the valve unit of this invention;

FIG. 6a is a sectional view of the valve unit included in the breaker of this invention, with the valve sleeve, the valve spool and the guide plug assembled into a single structure;

FIG. 6b is a sectional view of the valve unit of FIG. 6a, showing the operation of the valve unit; and

FIGS. 7, 8 and 9 are sectional views of the breaker of this invention, showing the operation of the breaker.

### DETAILED DESCRIPTION OF THE INVENTION

Reference now should be made to the drawings, in which the same reference numerals are used throughout the different drawings to designate the same or similar components.

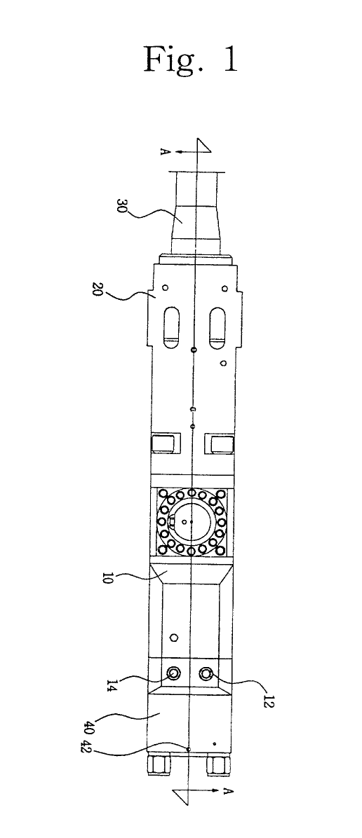

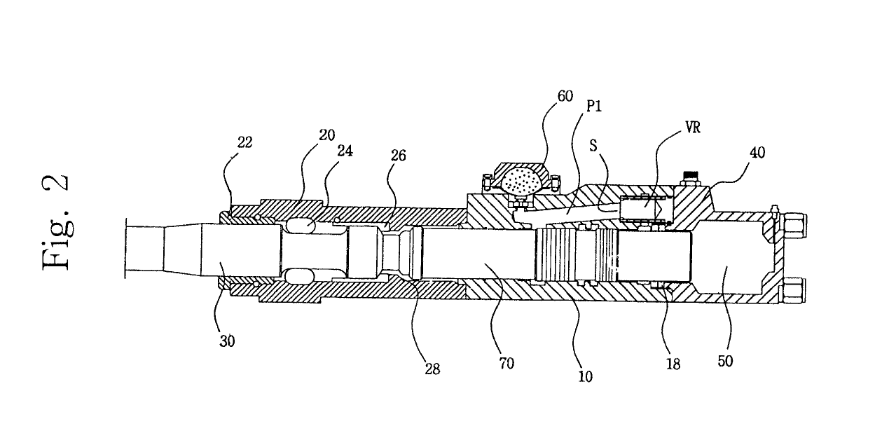

FIG. 1 is a view of a breaker in accordance with the preferred embodiment of the present invention. FIG. 2 is a sectional view of the breaker taken along the line A-A of FIG. 1.

As shown in the drawings, the breaker of this invention comprises a chisel case 20, a cylinder 20 fixed to the upper end of the chisel case 20, and a gas head chamber 40 fixed to the upper end of the cylinder 20.

A chisel 30 is movably set within the chisel case 20 such that the chisel 30 is movable within the case 20 in opposite directions. In such a case, the chisel 30 is partially inserted into the chisel case 20, while the remaining part of the chisel 30 is exposed to the outside from the lower end of the case 20.

The chisel 30 is a rod, of which the tip is brought into direct contact with a target hard object and breaks the object. The chisel 30 also has a saddle portion at a position inside the chisel case 20.

A chisel pin 24 is provided on the inner surface of the chisel case 20 at a position corresponding to the saddle portion of the chisel 30, and comes into contact with the saddle portion.

A guide ring 22 is inserted into the lower end of the chisel case 20. The outer diameter of the chisel 30 corresponds to the inner diameter of the guide ring 22.

A partition ring 28 is formed on the inner surface of the chisel case 20, while a thrust ring 26 having a predetermined length is fitted in the chisel case 20 such that the thrust ring 26 comes into contact with the partition ring 28 at its inside end. The thrust ring 26 extends from the partition ring 28 toward the guide ring 22.

The above thrust ring 26 guides a smooth movement of the chisel 30 within the chisel case 20. The thrust ring 26 also prevents the chisel 30 from coming into undesired frictional contact with the partition ring 28 and prevents damage or breakage of the chisel 30 or the partition ring 28 due to impact.

The chisel 30 is reduced in its diameter at a position around the partition ring 28, with a tapered step formed on the chisel 30 at a position around a stop end of the thrust ring 26 set in the chisel case 20. The chisel 30 thus comes into smooth contact with the stop end of the thrust ring 26. This chisel 30 is enlarged in its diameter to restore its maximum diameter after passing through the partition ring 28. In such a case, the second step of the reduced-diameter portion of the chisel 30 opposite to the tapered step is double-stepped, with the double-stepped second step of the chisel 30 being rounded on its external surface. The inside end of the chisel 30 is positioned such that it is hammered by the piston 70 set within the cylinder 10.

During an operation of the breaker, the chisel 30 is hammered by the piston 70, and is axially movable in opposite directions within a range defined by the saddle portion of the chisel 30 and the chisel pin 24 of the chisel case 20.

The cylinder 10 is coaxially mounted to the chisel case 20, and movably receives the piston 70 such that the piston 70 moves in the cylinder 10 in opposite directions to hammer the head of the chisel 30.

An oil inlet port 12 is formed on the sidewall of the cylinder 10, and introduces pressurized oil from an external oil source into the cylinder 10. An oil outlet port 14 is formed on the sidewall of the cylinder 10, and discharges the pressurized oil from the cylinder 10 to the outside of the cylinder 10. This oil outlet port 14 also communicates with an oil drain path 16 extending from a fourth oil path “PB” as will be described later herein.

A valve chamber “VR” is defined in a directional control valve unit “S” installed within the sidewall of the cylinder 10 at a predetermined portion. A first oil path “PI” extends from the valve chamber “VR” to the interior of the cylinder 10. The directional control valve unit “S” is set in the sidewall of the cylinder 10 to define the valve chamber “VR” therein. This valve unit “S” communicates with the first oil path “P1”.

The upper end of the cylinder 10 is assembled with a gas head 40.

The gas head 40 has a gas chamber 50, and closes the cylinder 10. In the cylinder 10, a sliding packing is set on the inner surface of the cylinder 10 within a predetermined section at a position around the junction of the cylinder 10 and the gas chamber 50, thus accomplishing a desired sealing effect at the junction of the cylinder 10 and the piston 70 during a movement of the piston 70 within the cylinder 10. The sliding packing thus allows a smooth movement of the piston 70, in addition to preventing an undesired oil leakage from the cylinder 10 into the gas chamber 50. The sliding packing also absorbs operational vibration of the piston 70 relative to the cylinder 10. A piston guide ring 18 is set on the inner surface of the cylinder 10 at a position around the sliding packing. A gas seal is set within the cylinder 10 at a position around the piston guide ring 18 to prevent an undesired leakage of nitrogen gas from the gas chamber 50 into the cylinder 10. A plurality of annular grooves are formed on the outer surface of the piston 70, and each hold an O-ring therein. The O-rings prevent an undesired leakage of oil and gas between the cylinder 10 and the gas chamber 50.

The above-mentioned sealing structure for preventing a leakage of oil and gas is well known to those skilled in the art, and further explanation for the sealing structure is thus not deemed necessary.

The valve unit “S” comprises a valve sleeve 200, a directional control valve spool 300 axially and movably set within the valve sleeve 200, and a guide plug 400 mounted to the upper end of the valve spool 300. The construction and operation of the valve unit “S” will be described in detail later herein.

The gas head 40, defining the gas chamber 50 therein, is mounted to the upper end of the cylinder 10 at a position opposite to the chisel case 20. A pressurized nitrogen gas is supplied into the gas chamber 50, thus periodically and pneumatically pushing the piston 70 toward the chisel 30.

A gas inlet valve 42 is formed on the sidewall of the gas head 40, and supplies a predetermined quantity of pressurized nitrogen gas from an external gas source into the gas chamber 50.

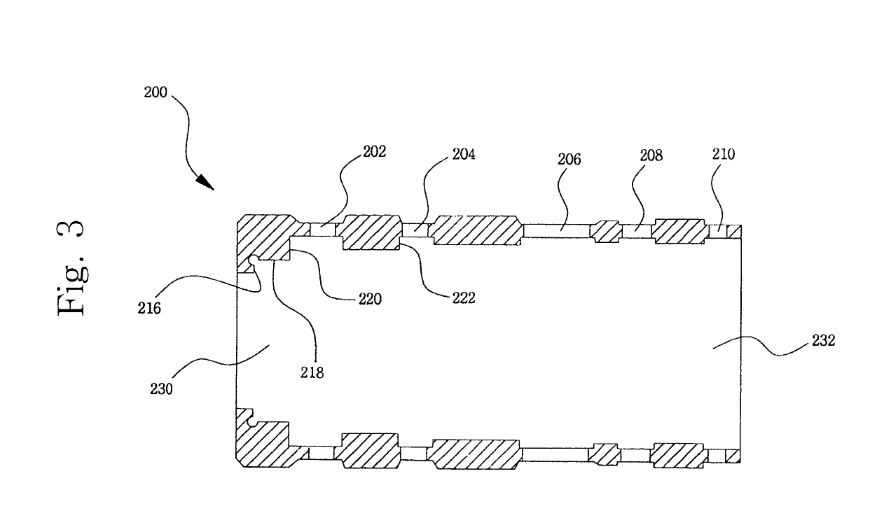

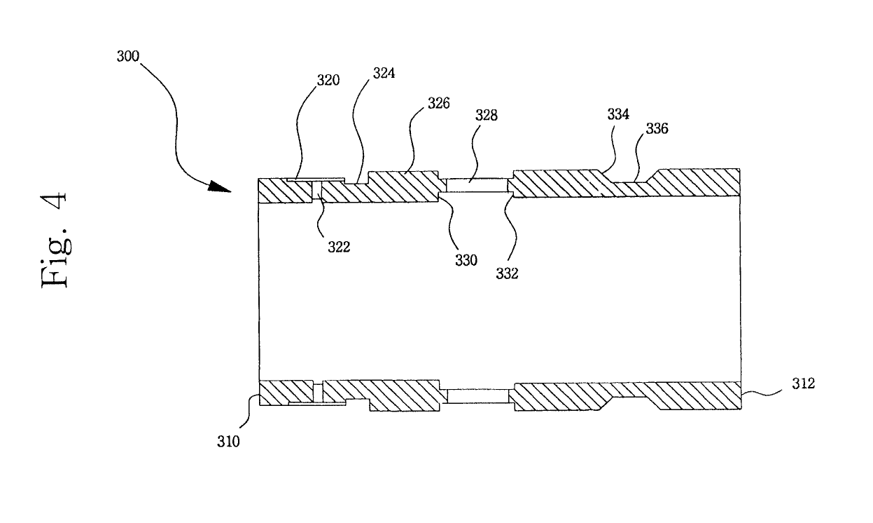

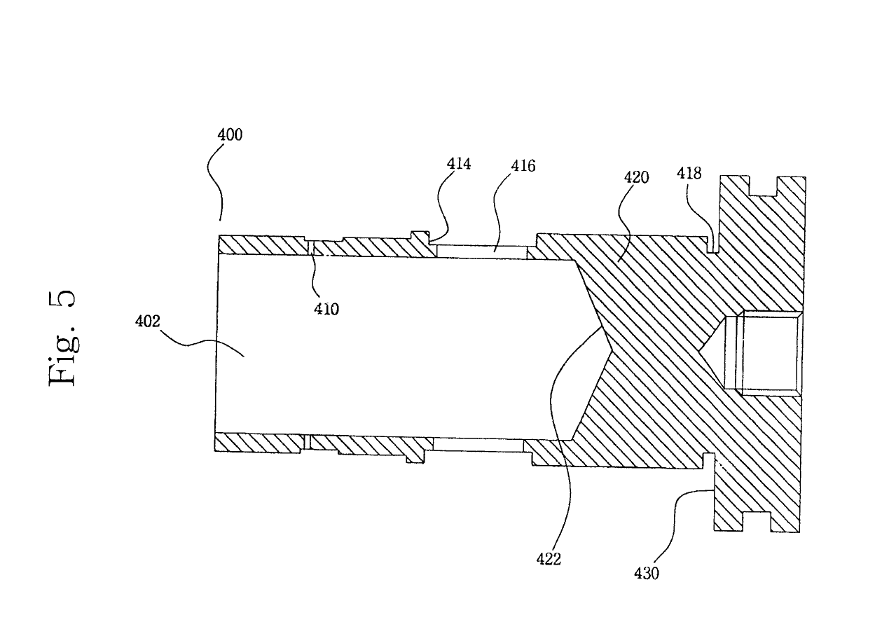

FIG. 3 is a sectional view of the valve sleeve 200 of the valve unit “S” of this invention. FIG. 4 is a sectional view of the valve spool 300 of the valve unit “S”. FIG. 5 is a sectional view of the guide plug 400 of the valve unit “S”.

As shown in FIG. 3, the valve sleeve 200 is a cylindrical member defining the valve chamber “VR”. The interior of the valve chamber “VR” extends upward from the end of the first oil path “P1”, and has a cylindrical shape with a diameter larger than that of the first oil path “P1”.

The opposite ends of the valve sleeve 200 are open. That is, the first end 230 of the valve sleeve 200 communicates with the first oil path “P1”, with the inner diameter of the first end 230 being equal to that of the first oil path “P1”. The second end 232 of the valve sleeve 200 has an inner diameter larger than that of the first end 230, and is closed by the guide plug 400 of FIG. 5.

The inner surface of the valve sleeve 200 is multi-stepped along an axial direction from the first to the second ends 230 and 232. That is, the inner surface of the valve sleeve 200 has a first stepped annular surface 216 at a position around the first end 230, a second stepped annular surface 220 at a position spaced apart from the first stepped annular surface 216 at a predetermined interval, and a third stepped annular surface 222 at a position spaced apart from the second stepped surface 220 at a predetermined interval.

A plurality of oil ports, or first to fifth oil ports 202, 204, 206, 208 and 210 having different diameters are formed along the sidewall of the valve sleeve 200. The oil ports 202, 204, 206, 208 and 210 are arranged in a direction from the first to second ends 230 and 232 of the sleeve 200, thus forming an axial arrangement of oil ports.

In the present invention, the third oil port 206 preferably has a diameter larger than that any one of the first, second, fourth and fifth oil ports 202, 204, 208 and 210.

The valve spool 300 of FIG. 4 is axially set within the valve sleeve 200 such that the spool 300 is axially movable within the sleeve 200 in opposite directions.

That is, the valve spool 300 is axially and movably set within the valve sleeve 200 such that the first end 310 of the spool 300 having a smaller outer diameter comes into contact with the first stepped annular surface 216 of the sleeve 200. In such a case, the second end 312 of the valve spool 300 has a larger outer diameter corresponding to that of the second end 232 of the valve sleeve 200. The second end 312 of the spool 300 is positioned inside the second end 232.

The length of the valve spool 300 is shorter than that of the valve sleeve 200, and so the spool 300 is axially movable within the sleeve 200 in opposite directions without being projected from the ends of the sleeve 200 during an operation of the valve unit “S”.

When the breaker is not operated, the valve spool 300 is positioned within the valve sleeve 200 at an initial position. At the initial position of the valve spool 300, the second stepped annular surface 220 of the sleeve 200 comes into contact with the first end 310 of the valve spool 300. In such a case, the first pressure outlet port 322 of the spool 300 is aligned with the first oil port 202 of the sleeve 200.

A cushion key groove 320 is axially formed on the outer surface of the sidewall of the valve spool 300 at a position outside of the pressure outlet port 322. The cushion key groove 320 thus allows the first oil port 202 of the valve sleeve 200 to communicate with an annular pressure groove 324 formed on the outer surface of the sidewall of the valve spool 300.

The annular pressure groove 324 is externally formed on the sidewall of the valve spool 300 at an appropriate position spaced apart from the pressure outlet port 322, and communicates with the second oil port 204 of the sleeve 200.

In the valve sleeve 300, a large outer-diameter part 326 axially extends from the annular pressure groove 324 toward the second end 312 of the sleeve 300. This large outer-diameter part 326 of the valve spool 300 is spaced apart from the third stepped annular surface 222 of the valve sleeve 200, and comes into movable contact with the inner surface of the sleeve 200 at a position between the second and third oil ports 204 and 206.

The above valve spool 300 is multi-stepped on its outer surface along an axial direction such that the outer diameter of the spool 300 is stepwisely enlarged to meet the shape of the multi-stepped inner surface of the valve sleeve 200. Therefore, when the valve spool 300 is axially set within the valve sleeve 200, the multi-stepped outer surface of the spool 300 comes into close and movable contact with the multi-stepped inner surface of the sleeve 200.

The valve spool 300 also has a spool port 328, which is formed on the sidewall of the spool 300 at a position allowing the spool port 328 to communicate with the third oil port 206 of the sleeve 200. The edge of the spool port 328 is depressed on the inner and outer surfaces of the sidewall of the spool 300, thus forming a lower step 330 and an upper step 332. An oil return groove 336 is annularly formed on the outer surface of the sidewall of the spool 300 at a position corresponding to the fourth oil port 208 of the valve sleeve 200. The opposite edges of the oil return groove 336 are tapered to form inclined surfaces 334.

The guide plug 400 of FIG. 5 is inserted into the upper end of the valve sleeve 200, with the valve spool 300 being movably set within an annular space left between the valve sleeve 200 and the guide plug 400. In such a case, the lower end of the guide plug 400 is stably set within both the first stepped annular surface 216 and small-diameter surface 218 of the sleeve 200.

The guide plug 400 has an axial opening 402. The axial opening 402 of the guide plug 400 communicates with the first oil path “P1”, which extends from the valve chamber “VR” to the interior of the cylinder 10. As described above, the first end of the guide plug 400, defining the opening 402, is set within both the first stepped annular surface 216 and small-diameter surface 218 of the sleeve 200.

The second end of the guide plug 400 forms a closing flange 430, which closes the second end 232 of the valve sleeve 200. A cushion groove 418 is formed on the guide plug 400 at the junction of the plug body and the closing flange 430 of the plug 400.

Therefore, the valve sleeve 200 and the guide plug 400 are assembled together while leaving a space between them due to the first to third stepped annular surfaces 216, 220 and 222 of the sleeve 200. The valve spool 300 is set in the above-mentioned space defined between the valve sleeve 200 and the guide plug 400.

The end 422 of the axial opening 402 of the guide plug 400 is formed to be concaved, forming a V-shaped cross-section, with a sixth oil port 416 formed on the sidewall of the plug body at a position around the end 422 of the opening 402. This sixth oil port 416 communicates with the third oil port 206 of the valve sleeve 200.

An annular step 414 is formed on the sidewall of the guide plug 400 along the edge of the sixth oil port 416, while a second pressure outlet port 410 having a cushion depression 412 is formed on the sidewall of the guide plug 400 at a position in front of the sixth oil port 416. The pressure outlet port 410 of the guide plug 400 communicates with the second oil port 204 of the valve sleeve 200 during a movement of the valve spool 300 within the valve sleeve 200.

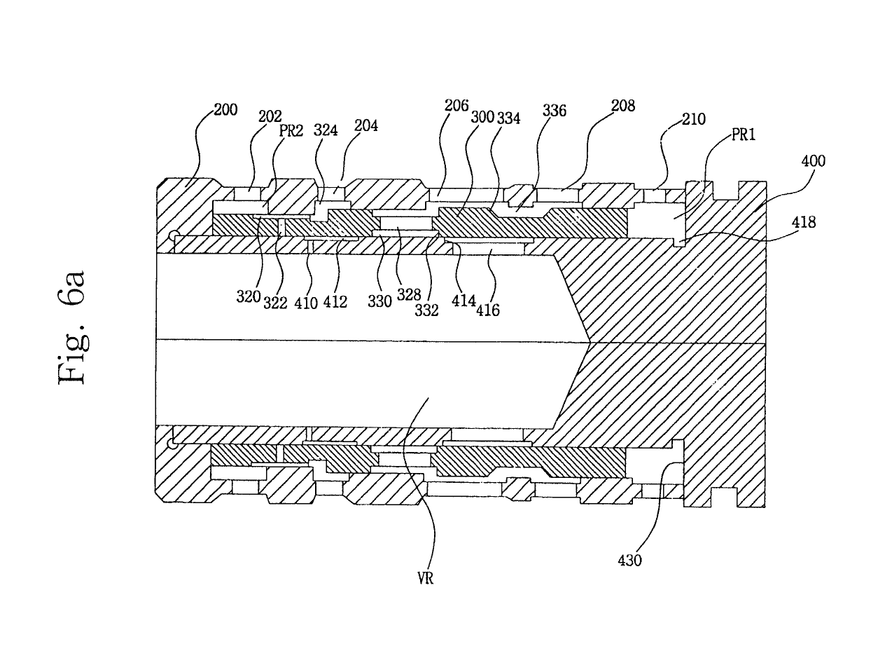

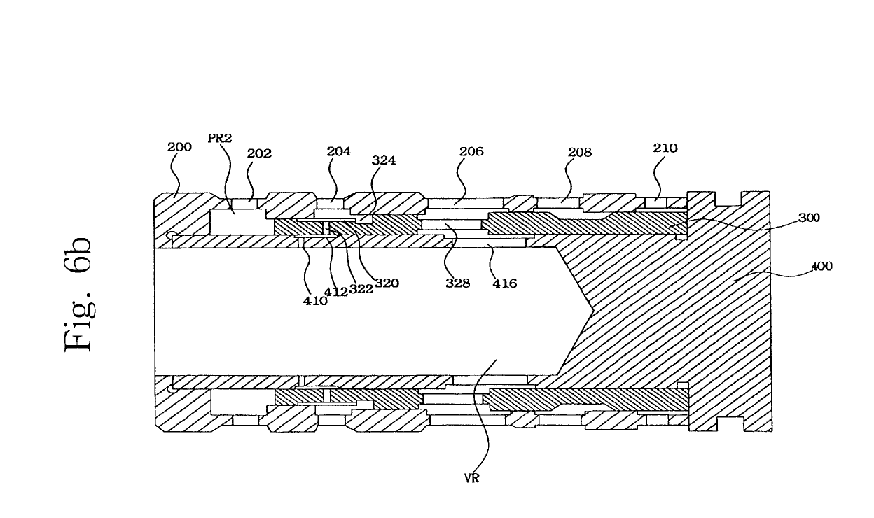

FIG. 6a is a sectional view of the valve unit “S” included in the breaker of this invention, with the valve sleeve 200, the valve spool 300 and the guide plug 400 assembled into a single structure. This drawing shows the valve unit “S” positioned at an initial position. FIG. 6b is a sectional view of the valve unit of FIG. 6a, showing the operation of the valve unit “S” when the breaker is operated to break a target hard object.

When the valve unit “S” is in its initial position as shown in FIG. 6a, the valve chamber “VR” of the valve unit “S” does not communicate with the outside of the valve chamber “VR” since the depressions, pressure outlet ports and oil ports of the valve sleeve 200, valve spool 300 and guide plug 400 are specifically and differentially formed.

That is, at the initial position of the valve unit “S”, both the second pressure outlet port 410 and sixth oil port 416 of the guide plug 400 are closed by the valve spool 300, while both the first pressure outlet port 322 and the spool port 328 of the valve spool 300 are closed by the guide plug 400. Therefore, the first to fifth oil ports 202, 204, 206, 208 and 210 of the valve sleeve 200 do not communicate with the valve chamber “VR”.

In such a case, the valve spool 300 within the valve sleeve 200 is fully moved to the left in the drawings, and so a first self-pressure space “PR1” is formed between the second end of the valve spool 300 and the closing flange 430 of the guide plug 400 at a position around the fifth oil port 210 of the valve sleeve 200. In addition, a second self-pressure space “PR2” is formed between the valve sleeve 200 and the valve spool 300 at a position around both the first oil port 202 of the valve sleeve 200 and the pressure outlet port 322 of the valve spool 300.

When the breaker starts its breaking operation, the valve spool 300 is moved within the valve sleeve 200 to the right as shown in FIG. 6b, and so the first self-pressure space “PR1” is removed from the valve unit “S”. In such a case, the pressure outlet port 410 of the guide plug 400 communicates with the pressure outlet port 322 of the valve spool 300 through the cushion depression 412 of the plug 400. The pressure outlet port 322 of the valve spool 300 communicates with the second oil port 204 of the valve sleeve 200 through the cushion key groove 320.

In addition, the sixth oil port 416 of the guide plug 400 communicates with the third oil port 206 of the valve sleeve 200 through the spool port 328 of the valve spool 300.

Therefore, the valve chamber “VR” selectively communicates with the outside of the valve sleeve 200.

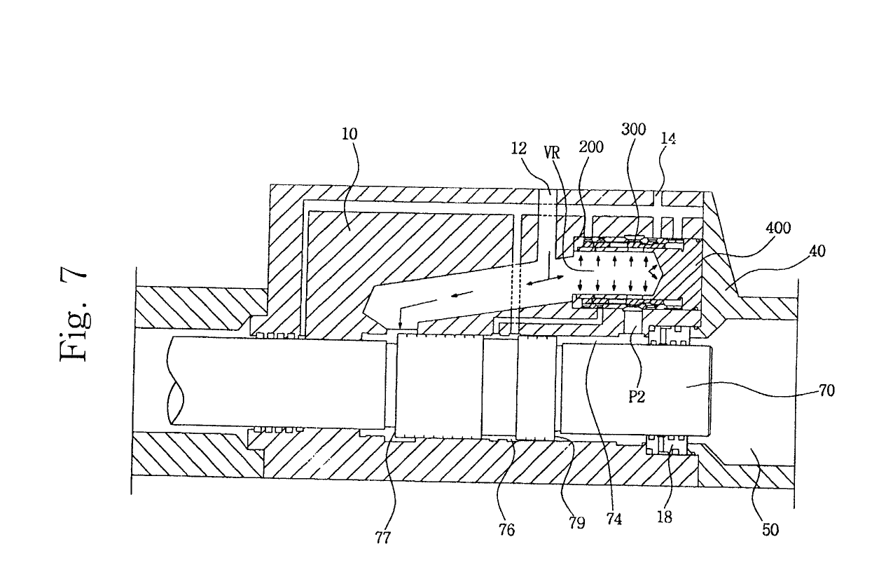

The operation of the breaker according to this invention will be described herein below with reference to FIGS. 7, 8 to 9.

When highly pressurized oil is fed to the breaker of this invention in the initial position, the oil partially flows in the first oil path “P1” to reach the first chamber 72 inside the cylinder 10 as shown in FIG. 7. In such a case, the oil also partially flows into the valve chamber “VR”. However, since the sidewall of the valve unit “S” is closed, the oil returns from the valve chamber “VR” to the first oil path “P1”, and flows into the first chamber 72 within the cylinder 10.

The highly pressurized oil, introduced into the first chamber 72 defined within the cylinder 10 at a position around both the outlet end of the first oil path “P1” and the piston 70, biases the first stepped surface 77 of the piston 70.

Therefore, the piston 70 axially moves in the cylinder 10 to the right in the drawings due to the pressure of the oil. That is, the piston 70 moves toward the gas chamber 50 of the gas head 40.

In such a case, the piston guide ring 18 is set on the inner surface of the cylinder 10 at a position around the sliding packing, with the gas seal set within the cylinder 10 at a position around the piston guide ring 18, and so the nitrogen gas within the gas chamber 50 does not leak through the junction of the cylinder 10 and the piston 70 during the movement of the piston 70 within the cylinder 10.

Due to the movement of the piston 70 in the cylinder 10, the nitrogen gas within the gas chamber 50 is compressed, thus becoming highly pressurized.

During the movement of the piston 70 in the cylinder 10, the second stepped surface 79 of the piston 70 moves in the same direction while allowing the oil to flow from the second chamber 74 into the third oil port 206 of the valve sleeve 200 through the second oil path “P2”. The oil is, thereafter, introduced into the fourth oil port 208 of the valve sleeve 200 along the inclined surfaces 334 and the oil return groove 336 of the valve spool 300 prior to being discharged from the valve unit “S” through the oil outlet port 14 of the cylinder 10.

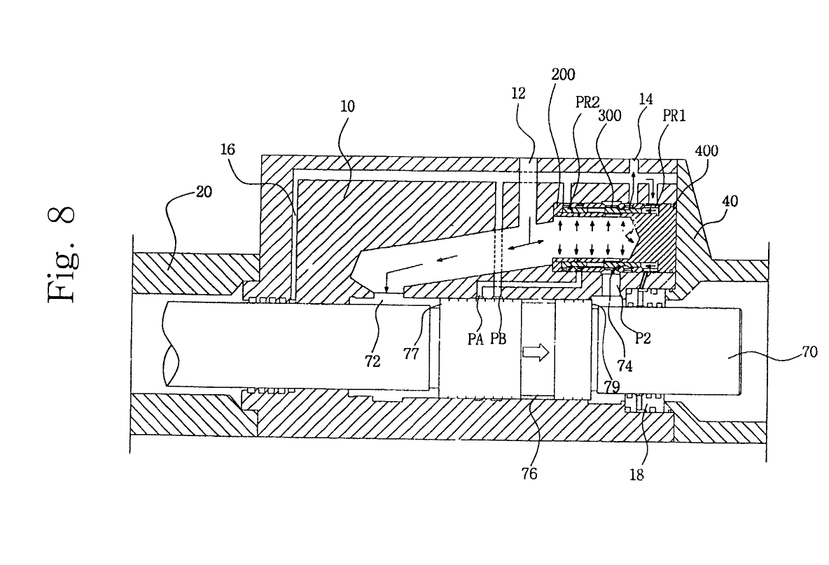

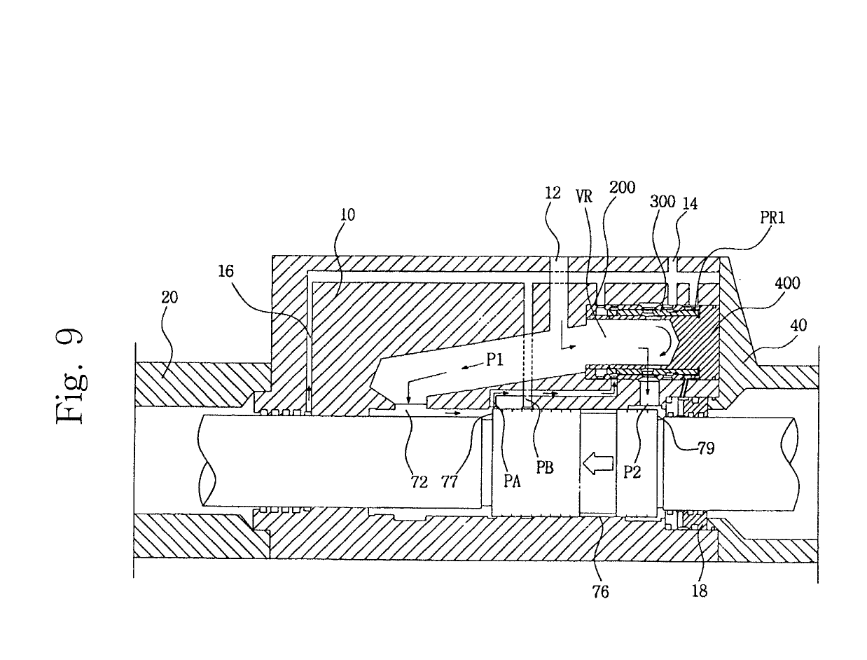

Due to the movement of the piston 70 in the cylinder 10, the first chamber 72 of the cylinder 10 communicates with a third oil path “PA” as shown in FIGS. 8 and 9. In such a case, the highly pressurized oil flows from the first chamber 72 to the second oil port 204 of the valve sleeve 200 through the third oil path “PA”.

The highly pressurized oil, introduced into the second oil port 204 of the valve sleeve 200, pushes the annular pressure groove 324 formed on the external surface of the sidewall of the valve spool 300 at a position around the junction of the small-diameter part and the large-diameter part of the spool 300. Therefore, the valve spool 300 accomplishes its initial stage, at which the spool 300 starts to move toward the first self-pressure space “PR1” of FIGS. 6a and 6b.

In such a case, both the first and second self-pressure spaces “PR1” and “PR2” are maintained at their low-pressure states. On the other hand, the nitrogen gas within the gas chamber 50 is highly pressurized to form a gas expansion force. In addition, pressurized oil is contained in an oil accumulator 60 of FIG. 2, and may be quickly and controllably fed to the cylinder 10.

In such a case, both the first oil path “P1” and the valve chamber “VR” of the guide plug 400 are extremely pressurized.

The valve spool 300 starts to move toward the first self-pressure space “PR1” while allowing the third oil port 206 of the valve sleeve 200, the spool port 328 of the valve spool 300, and the sixth oil port 416 of the guide plug 400 to communicate with each other. Therefore, the pressurized oil within the valve chamber “VR” flows to the second chamber 74 through the second oil path “P2”, and pushes the second stepped surface 79 of the piston 70 to the left in the drawings. The piston 70 thus hammers the chisel 30.

In such a case, the fourth oil port 208 of the valve sleeve 200 is closed by the valve spool 300 as shown in FIG. 6b, and so the pressurized oil is not discharged. In addition, both the first oil path “P1” and the first chamber 72 communicate with the pressure outlet port 410, the cushion depression 412, the pressure outlet port 322, and the cushion key groove 320 through the third oil path “PA” as shown in FIG. 6b. Therefore, the pressure inside the first chamber 72 is reduced to become remarkably lower than that of the second chamber 74.

Due to a pressure difference between the first and second chambers 72 and 74, the piston 70 quickly moves to the left in the drawings. In such a case, the gas pressure of the gas chamber 50 cooperates with the oil pressure difference between the two chambers 72 and 74, thus more strongly moving the piston 70 to the left.

During the movement of the piston 70, the oil accumulator 60 appropriately controls the variable oil pressure, and so it is possible to eliminate any hydraulic vibrations of the breaker.

In such a case, positive pressure acts on both the inclined surfaces 334 and the lower step 330 of the valve spool 300, and so the valve spool 300 automatically moves in a direction from the first self-pressure space “PR1” to the second self-pressure space “PR2”, thus automatically restoring its initial position.

When the third chamber 76, provided at the middle portion of the piston 70, communicates with the fourth oil path “PB” during the movement of the piston 70 for forming the hammering action, the pressurized oil in the third oil path “PA” flows through the fourth oil path “PB” and the oil drain path 16. The pressurized oil is, thereafter, discharged from the cylinder 10 through the oil outlet port 14, thus initializing the pressure of the third chamber 76.

When the valve spool 300 returns to its initial position during an operation, existing pressure is removed from both the cushion key groove 320 and the annular pressure groove 324 of the valve spool 300, thus becoming almost zero.

When one hammering stroke of the breaker is completely accomplished, highly pressurized oil is newly supplied to the first oil path “P1” through the oil inlet port 12 and performs another hammering stroke in the same manner as that described above. Such a hammering stroke is repeated to perform a desired breaking operation of the breaker.

As described above, the present invention provides a breaker operated using pneumatic pressure and hydraulic pressure.

In the breaker of this invention, the passage formed by both the second chamber of the cylinder defined above the piston and an oil port of the valve sleeve is directly opened or closed, and so it is possible to move the valve spool within the valve sleeve without being disturbed by hydraulic pressure. The valve spool and the valve sleeve are less likely to be scratched due to an excessive expansion of oil within the valve unit.

In addition, both the hydraulic pressure of the actuation oil and the pneumatic pressure of the nitrogen gas act on the piston within the cylinder at the same time, and so it is possible to maximize the hammering force of the breaker without changing the shape or size of the breaker.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A breaker using pneumatic and hydraulic pressures, comprising a chisel, a chisel case receiving said chisel and guiding an axial movement of the chisel within a stroke, a cylinder assembled with the chisel case and coaxially receiving a piston used for hammering the chisel, and a gas chamber provided at an upper end of the cylinder and containing nitrogen gas and selectively compressing the nitrogen gas in response to an axial movement of the piston within the cylinder, further comprising:
first and second stepped surfaces formed on an outer surface of said piston, thus changing an outer diameter of the piston and forming first and second chambers between the outer surface of the piston and an inner surface of the cylinder;
a third chamber defined between the piston and the cylinder at a position between the first and second chambers;
a first oil path formed in a sidewall of said cylinder and allowing an oil inlet port of the cylinder to communicate with said first chamber, thus feeding pressurized oil from an external oil source to the first chamber;
a valve chamber formed in the sidewall of the cylinder while extending from the first oil path in a direction opposite to the first chamber;
a second oil path formed in the sidewall of the cylinder so as to allow the valve chamber to selectively communicate with the second chamber;
a directional control valve unit installed within said valve chamber and used for selectively returning the pressurized oil from the first chamber to the valve chamber prior to feeding the pressurized oil from the valve chamber to the second chamber through a plurality of oil ports thereof and said second oil path;
a third oil path formed in the sidewall of the cylinder at a position between said first and second oil paths, and selectively communicating with the valve chamber through said valve unit in response to an axial movement of the piston within the cylinder; and
a fourth oil path formed in the sidewall of the cylinder at a position around the third oil path, and used for discharging the pressurized oil from the third chamber through an oil drain path, thus making the pressure of the third chamber become zero and initializing the pressure of the third chamber.

2. The breaker according to claim 1, wherein said directional control valve unit comprises:
a valve sleeve opened at its opposite ends and installed in said valve chamber, with first, second and third stepped annular surfaces formed on an inner surface of the sleeve along an axial direction to stepwisely enlarge an inner diameter of the sleeve, said valve sleeve also having first, second, third, fourth and fifth oil ports on its sidewall;
a valve spool movably and closely set within said valve sleeve and multi-stepped on its outer surface to meet the multi-stepped inner surface of said valve sleeve, with the sidewall of said valve spool having a first pressure outlet port selectively communicating with the first and second oil ports of the valve sleeve, a spool port selectively communicating with the third and fourth oil ports of the valve sleeve, and an annular pressure groove formed at a position between the first pressure outlet port and the spool port and having an outer diameter larger than that of the pressure outlet port; and
a guide plug axially inserted into one open end of said valve sleeve and held by a gas head defining the gas chamber, with the valve spool axially and movably positioned between the valve sleeve and the guide plug, said guide plug thus closing the open ends of both the valve sleeve and the valve spool, said guide plug having a second pressure outlet port on its sidewall so as to selectively communicate with the first pressure outlet port of said valve spool in response to an axial movement of the valve spool within the valve sleeve, with a sixth oil port formed on the sidewall of the guide lug at a position around the second pressure outlet port and selectively communicating with the spool port of the valve spool.

3. The breaker according to claim 1, wherein said valve spool has a length shorter than that of said valve sleeve.

4. The breaker according to claim 3, further comprising:
a first self-pressure space formed between the end of the valve spool and the guide plug at a position around the fifth oil port of the valve sleeve;
a second self-pressure space formed between the valve sleeve and the valve spool at a position around both the first oil port of the valve sleeve and the pressure outlet port of the valve spool;
a cushion key groove formed on an outer surface of the sidewall of the valve spool at a portion around the first pressure outlet port, said key groove communicating both the first and second oil ports of the valve sleeve with the first pressure outlet port of the valve spool during an axial movement of the valve spool toward an upper dead point within the valve sleeve, and communicating only the second oil port of the valve sleeve with the first pressure outlet port after the valve spool completely reaches the upper dead point;
an oil return groove formed on the outer surface of the sidewall of said valve spool so as to selectively communicate with the third and fourth oil ports of the valve sleeve during an axial movement of the valve spool, thus discharging the pressurized oil from the second chamber of the cylinder to the outside of said cylinder through an oil outlet port; and
a cushion depression axially formed on an outer surface of the sidewall of said guide plug at a position around the second pressure outlet port of the guide plug, said cushion depression allowing the second pressure outlet port of the guide plug to selectively communicate with the first pressure outlet port of the valve spool in response to an axial movement of the piston toward the upper dead point within the cylinder, thus allowing the pressurized oil to flow from the first chamber of the cylinder to the valve chamber through both the third oil path of the cylinder and the second oil port of the valve sleeve.

5. The breaker according to claim 2, wherein said valve spool has a length shorter than that of said valve sleeve.

6. The breaker according to claim 5, further comprising:
a first self-pressure space formed between the end of the valve spool and the guide plug at a position around the fifth oil port of the valve sleeve;
a second self-pressure space formed between the valve sleeve and the valve spool at a position around both the first oil port of the valve sleeve and the pressure outlet port of the valve spool;
a cushion key groove formed on an outer surface of the sidewall of the valve spool at a portion around the first pressure outlet port, said key groove communicating both the first and second oil ports of the valve sleeve with the first pressure outlet port of the valve spool during an axial movement of the valve spool toward an upper dead point within the valve sleeve, and communicating only the second oil port of the valve sleeve with the first pressure outlet port after the valve spool completely reaches the upper dead point;
an oil return groove formed on the outer surface of the sidewall of said valve spool so as to selectively communicate with the third and fourth oil ports of the valve sleeve during an axial movement of the valve spool, thus discharging the pressurized oil from the second chamber of the cylinder to the outside of said cylinder through an oil outlet port; and
a cushion depression axially formed on an outer surface of the sidewall of said guide plug at a position around the second pressure outlet port of the guide plug, said cushion depression allowing the second pressure outlet port of the guide plug to selectively communicate with the first pressure outlet port of the valve spool in response to an axial movement of the piston toward the upper dead point within the cylinder, thus allowing the pressurized oil to flow from the first chamber of the cylinder to the valve chamber through both the third oil path of the cylinder and the second oil port of the valve sleeve.
